(19) United States
(12) Patent Application Publication
(10) Pub. No.: US 2009/0285512 A1
(43) Pub. Date: Nov. 19, 2009

(54) ROLLER BEARING, ROLLER BODY FOR A ROLLER BEARING, AND DEVICE HAVING ROLLER BEARINGS

(75) Inventor: Karl Gebert, Schweinfurt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/465,268

(22) Filed: May 13, 2009

(30) Foreign Application Priority Data
May 14, 2008 (EP) EP08008926

(51) Int. Cl. F16C 29/06; F16C 19/24

(52) U.S. Cl. 384/44; 384/548

(57) ABSTRACT

A roller bearing includes an outer ring of metal, an inner ring of metal, and at least one roller body which is made of a material which includes ceramic, with carbon nanotubes and/or carbon nanofibers being embedded in the ceramic material of the roller body. As a result, the roller body is rendered electrically conductive, and allows measurement of a thickness of a lubricating film in the roller bearing. Furthermore, heat is carried from the inner ring to the outer ring as a result of increased thermal conductivity.

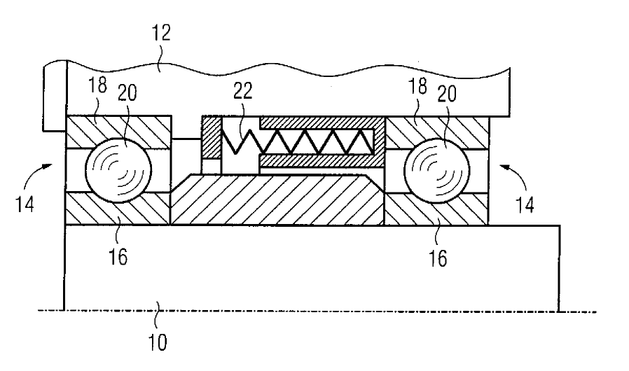

### CROSS-REFERENCES TO RELATED APPLICATIONS

This application claims the priority of European Patent Application, Serial No. EP08008926, filed May 14, 2008, pursuant to 35 U.S.C. 119(a)-(d), the content of which is incorporated herein by reference in its entirety as if fully set forth herein.

### BACKGROUND OF THE INVENTION

The present invention relates, in general, to a roller bearing, roller body for a roller bearing, and a device having roller bearings.

The following discussion of related art is provided to assist the reader in understanding the advantages of the invention, and is not to be construed as an admission that this related art is prior art to this invention.

A roller bearing of a type involved here is a so-called hybrid roller bearing which has outer and inner rings made of metal, e.g. steel, and roller bodies which are made entirely of ceramic, for example of silicon nitride. Hybrid roller bearings are particularly suitable for applications in which one of the rings is intended to rotate at high rotation speeds with respect to the other ring. The use of ceramic material has been considered beneficial because it results in better rolling characteristics of the roller bodies when there is a lack of lubricant, so that the roller bodies are subject to less wear. Particularly when the inner ring is prestressed with respect to the outer ring and the roller bodies run along shoulders on the two rings at high rotation speeds, the roller bodies are subject to particularly high centrifugal forces. This is the case in applications of roller bearings in machine tools and other machines in which a moving part is moved at high rotation speeds with respect to a stationary part. Since ceramic roller bodies have only one third of the relative density of steel balls which are used in other roller bearings, the roller bodies are not subject to such a high centrifugal force as that of steel balls.

However, the hybrid roller bearings also have disadvantages. As insulators, ceramic bodies are poor electrical conductors, and therefore also poor thermal conductors.

In the case of roller bearings in which all the components are composed of steel, the lubricant film thickness can be determined electrically. The lubricant film which is provided by the necessary lubricant represents an insulation layer for an electrical capacitance, and, at the same time, it acts as a resistance element connected in parallel with the capacitance. The lubricant film thickness can be deduced by a capacitance measurement. For this purpose, a current, typically an alternating current, is sent via the outer ring, the lubricating film between the outer ring and the roller bodies, the roller bodies, the lubricating film between the roller bodies and the inner ring, and the inner ring, and the voltage drop is measured. The lubricating film thickness now provides information about the quality of the lubrication, which has an influence on the raceway wear and component wear in the roller bearing, that is to say information indicating the load on the roller bearing, as a result of which it is possible to deduce the state of the entire roller bearing. If the lubricating film thickness is inadequate, operation of the roller bearing can be interrupted and, if required, lubricant can be supplied. The lubricating film thickness measurement is frequently carried out continuously in order to ensure that, as far as possible, the bearing is never in a situation in which it is subject to severe wear.

Since the silicon-nitride roller bearings are not electrically conductive, it has not been possible until now to measure the lubricating film thickness in a hybrid roller bearing.

It would therefore be desirable and advantageous to address prior art shortcomings and to make it possible to measure the lubricating film thickness in a hybrid roller bearing.

### SUMMARY OF THE INVENTION

According to one aspect of the present invention, a roller bearing including an outer ring of metal, an inner ring of metal, and at least one roller body made of a material which includes ceramic, with carbon nanotubes and/or carbon nanofibers being embedded in the ceramic material of the roller body.

The present invention resolves prior art problems by effectively “doping” the ceramic material. Carbon nanotubes are microscopically small tubular structures (molecular nanotubes) composed of carbon, and are also referred to as CNT (carbon nanotubes). Carbon nanotubes are electrically conductive and, when carbon nanotubes such as these are used in the ceramic material, they can make the ceramic material electrically conductive. If a sufficient quantity of carbon nanotubes or carbon nanofibers is provided, the roller bodies can reach at least 1/2000th and even at least 1/1000th of the electrical conductivity of copper. It is even possible to achieve up to 100th of the electrical conductivity of copper. Conductivity in the stated order of magnitude is sufficient to allow the thickness of the lubricating film on the roller bearing to be measured.

According to another advantageous feature of the present invention, the roller body may contain silicon nitride. Silicon nitride has particularly advantageous characteristics for roller bearings involved here.

According to another aspect of the present invention, a roller body for a roller bearing is made of ceramic material in which carbon nanotubes and/or carbon nanofibers are embedded. Suitably, the ceramic material is silicon nitride.

According to yet another aspect of the present invention, a device includes a stationary part, a moving part movable in relation to the stationary part, and at least one roller bearing movably supporting the moving part with respect to the stationary part, with the roller bearing including an outer ring of metal, an inner ring of metal, and at least one roller body made of a material which includes ceramic, with carbon nanotubes and/or carbon nanofibers being embedded in the ceramic material of the roller body.

In the event the device is a machine tool or a spindle machine, according to another advantageous feature of the present invention, the inner ring of the roller bearing can be prestressed with respect to the outer ring. Suitably, a spring is supported on the moving part and presses the inner ring against the outer ring via the roller body.

According to another advantageous feature of the present invention, a measuring unit may be provided for measurement of a signal which is dependent on a thickness of a lubricating film of lubricant in the roller bearing. The measurement unit may include an electrical power source and a voltmeter and measures a voltage drop across the roller bearing, when current is applied to the roller bearing. Currently preferred is a continuous measurement of the thickness of the lubricating film thickness during operation of the device. Measurement can hereby be stabilized by providing an alternating current at a changing frequency, and by specifically measuring the voltage that occurs in this case.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a schematic illustration of an arrangement with two roller bearings, embodying the subject matter of the present invention.

### DETAILED DESCRIPTION OF PREFERRED EMBODIMENTS

The depicted embodiment is to be understood as illustrative of the invention and not as limiting in any way. It should also be understood that the FIGURE is not necessarily to scale. Details which are not necessary for an understanding of the present invention or which render other details difficult to perceive may have been omitted.

Turning now to the FIGURE, there is shown an arrangement having a moving part 10 which is intended to be moved with respect to a stationary housing 12 and is in this case borne via roller bearings 14 with respect to this housing 12. The roller bearings 14 each comprise an outer ring 18 and an inner ring 16, between which a roller body, in the present case a ball 20, is arranged. In the present case, the roller bearing 14 is adjusted, that is to say a spring 22 is provided, which is supported on the stationary part 12 and exerts pressure on the outer ring 18, which passes this on via the roller bearing 20 to the inner ring 16.

In the case of roller bearings in the form of the roller bearings 14, which are typically used in machine tools and other devices in which the moving part 10 is rotated at extremely high rotation speeds, the outer ring 18 and the inner ring 16 are produced from steel, and the roller bodies are produced from ceramic material. In the present case, carbon nanotubes and/or carbon nanofibers are embedded in this ceramic material, and result in the roller bodies 20 becoming electrically conductive.

It is therefore possible to measure the thickness of a lubricating film, which is not shown in the FIGURE, between a roller body 20 and an inner ring 16 or roller body 20 and an outer ring 18 and, if necessary, to provide further lubrication or to cease operation of the device.

The electrical conductivity of the roller bodies 20 is also associated with an increased thermal conductivity. In the case of roller bearings which rotate at high speed, the inner rings 16 in particular are heated severely. In the case of conventional hybrid bearings, temperature differences of up to 40° C. can occur with respect to the outer ring 18, which adversely affect the operation of the device, as a result of which it may be necessary to reduce the maximum possible rotation speed or to provide cooling for the inner ring 16 and/or the moving part 10. In the present case, there is no need for such complex cooling, because the heat is adequately dissipated because of the better thermal conductivity of the roller bodies 20.

The range of operation of roller bearings is thus extended, and the life of the roller bearings is lengthened in the case of extreme applications, for example in the case of devices in which high rotation speeds occur.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A roller bearing, comprising:
an outer ring of metal;
an inner ring of metal; and
at least one roller body made of a material which includes ceramic, with carbon nanotubes and/or carbon nanofibers being embedded in the ceramic material of the roller body.

2. The roller bearing of claim 1, wherein the roller body contains silicon nitride.

3. A roller body for a roller bearing, said roller body being made of ceramic material in which carbon nanotubes and/or carbon nanofibers are embedded.

4 The roller body of claim 3, wherein the ceramic material is silicon nitride.

5. A device, comprising:
a stationary part;
a moving part movable in relation to the stationary part; and
at least one roller bearing movably supporting the moving part with respect to the stationary part, said roller bearing including an outer ring of metal, an inner ring of metal, and at least one roller body made of a material which includes ceramic, with carbon nanotubes and/or carbon nanofibers being embedded in the ceramic material of the roller body.

6. The device of claim 5, wherein the inner ring of the roller bearing is prestressed with respect to the outer ring.

7. The device of claim 6, further comprising a spring supported on the moving part to press the inner ring against the outer ring via the roller body.

8. The device of claim 5, further comprising measuring means for measurement of a signal which is dependent on a thickness of a lubricating film of lubricant in the roller bearing.
